(19) United States
(12) Patent Application Publication
(10) Pub. No.: US 2007/0044524 A1
(43) Pub. Date: Mar. 1, 2007

(54) Internal locking apparatus and methods for making and using same

(75) Inventors: Richard Alfred Coutermarsh, Kingwood, TX (US); John Reid Eastman, Kingwood, TX (US); Mark James Miller, Allen, TX (US)

Correspondence Address: ROBERT W STROZIER, P.L.L.C, PO BOX 429, BELLAIRE, TX, 77402-0429, US

(73) Assignee: InnerLoc, LLC, A Texas Limited Liability Corporation

(21) Appl. No.: 11/509,333

(22) Filed: Aug. 24, 2006

Related U.S. Application Data
(60) Provisional application No. 60/710,755, filed on Aug. 24, 2005.

(51) Int. Cl. E05B 65/12

(52) U.S. Cl. 70/257

(57) ABSTRACT

An internal locking system is disclosed, which utilizes electro-mechanical locking devices to lock and unlock lockable openings.

### RELATED APPLICATIONS

This application claims priority of U.S. Provisional Patent Application Ser. No. 60/710755, filed Aug. 24, 2005.

### BACKGROUND OF THE INVENTION

1. Field of the Invention

The present invention relates to an apparatus for locking containers from the inside and to methods for making and using same.

More particularly, the present invention relates to an apparatus for locking containers from the inside, where the apparatus locking assembly selected from the group consisting of worm screw drives, linear actuator drives, cam drive, or the like, and a remotely accessible control assembly and to methods for making and using same.

2. Description of the Related Art

Although most doors are locked on the outside using a variety of locking mechanisms, such outside locking devices are prone to unwanted and/or unlawfully enter either by tampering with the locking mechanism or destroying the locking mechanism.

In recent years, several devices have been developed to lock containers from the inside, where the locking mechanism is activated from the outside by a tough pad or some type of remote activation device. The two systems currently known in the art are a pneumatic device and an electrical device. The pneumatic device is described in PCT published patent application WO2004033322. The electrical device is described at the web site:

Even though a recent trend toward internal locking mechanisms is making in roads into the industrial industries, there is still a need in the art for internal locking mechanisms that are simple to operate, are compact and are reliable.

### SUMMARY OF THE INVENTION

The present invention provides an internal locking apparatus including a locking system and an electronic control system, where the locking system includes a locking assembly selected from the group consisting of a worm screw drive, a linear actuator drive, a cam drive or the like, where the locking system is designed to be mounted inside a container and the locking assembly is designed to transition between a locked position and an unlocked position, which locks or unlocks a lockable opening such as an opening of container, room, storage chamber, etc. The electronic control system is designed to provide power to the locking system to change its state from the locked position to the unlocked position or vis-a-versa.

The present invention also provides an apparatus including a plurality locking systems and an electronic control system, where the locking system includes a locking assembly selected from the group consisting of a worm screw drive, a linear actuator drive, a cam drive or the like, where the locking system is designed to be mounted inside a container and the locking assembly is designed to transition between a locked position and an unlocked position, which locks or unlocks a lockable opening such as a container door. The electronic control system is designed to provide power to the locking systems to change their state from the locked position to the unlocked position or vis-a-versa.

The apparatus can also include a plurality of locking systems. In the case of apparatuses that include multiple locking systems, each locking system will have its own drive. When the locking systems are independently controlled, then security is higher, but manual locking and/or unlocking are more time consuming. Of course, if the locking systems are controlled via telemetry (Rf, IR, nearIR, sonic, microwave, radar, etc.), then each locking system can be on a separate frequency, have a separate code or a combination, thereof to further increase security, yet not slowing down locking and unlocking operations.

The present invention provides a method for locking a door or an opening including the step of mounting a locking system of this invention on an inner surface of a door or opening or an inner surface of a wall adjacent the door or opening. Once the locking system is mounted, a power source mounted on the inner surface of the door and/or in an interior of the container, room, cavity, compartment, or a similar enclosure in electrical communication with the locking system is installed. Once the system and the power source are mounted and installed, an electronic control system is installed within the interior and connected to the locking system. The electronic control system includes a command generator component for causing the locking system to transition from an unlocked position to a locked position or vis-a-versa. The electronic control system can also include a receiver component or unit capable of receiving an activation signal instructing the electronic control system to issue a command to the locking system(s) to cause the locking system(s) to transition between its (their) two states. The electronic control system can also include a transmitter component or unit, where the transmitter unit is capable of transmitting an authentication signal designed to authenticate the activation signal and is capable of transmitting a completion signal (which can be a success signal, a no success signal, an error signal or a no success signal and an error signal). The receiver component or unit is also capable of receiving a verification signal verifying the authenticity of the activation signal. The electronic control component can also include an external entry unit such as a keypad, touch pad or another encoded unit such as a finger print pad, a palm print pad, a retinal scanner, or other similar encoded unit, where the external unit is designed to generate a signal to transition the locking system between its locked and unlocked positions or vis-a-versa.

The method can also include the step of installing multiple locking systems and a single electronic control system or each locking system can have its own power supply and electronic control system. The method can also include sending and receiving signals from the single electronic control system or the individual electronic systems that cause the locking systems to transition between their locked and unlocked positions or vis-a-versa.

### BRIEF DESCRIPTION OF THE DRAWINGS

The invention can be better understood with reference to the following detailed description together with the appended illustrative drawings in which like elements are numbered the same:

FIGS. 1A&B depict a preferred embodiment of a container internal locking system of this invention;

FIGS. 1C&D depict another preferred embodiment of a container internal locking system of this invention;

FIGS. 1E&F depict another preferred embodiment of a container internal locking system of this invention;

FIGS. 2A&B depict another preferred embodiment of a container internal locking system of this invention;

FIGS. 2C&D depict another preferred embodiment of a container internal locking system of this invention; and

FIGS. 2E&F depict another preferred embodiment of a container internal locking system of this invention.

### DETAILED DESCRIPTION OF THE INVENTION

The inventors have found that a locking apparatus for any container accessible by a door or an opening can be installed within an interior of the container, where the locking apparatus permits the door or opening to be locked from the inside so increase container security. The inventors have found that a electro-mechanical drive system provides superior performance, superior reliability, is compact and easily serviced.

The present invention broadly relates to an internal locking apparatus including a electro-mechanical locking system and an electronic control system. The locking system includes an electro-mechanical locking assembly and a source of electrical energy for powering in electrical communication with the locking assembly, while the electronic control system is in electrical communication with the locking system and controls the locking system. The locking assembly moves between a retracted position (an unlocked position) and an extended position (a locked position). The electronic control system includes a receiver and optionally a transmitter. The power supply and the drive are electrically connected to the electronic control system so that when a state transition signal is received by the electronic control system via its receiver, a signal is sent to the power supply and/or the drive to either extend or retract the locking member depending on its present state. Thus, if the locking member is extended, then the signal will cause the member to be retracted and vis-a-versa. The electronic control system can also include a transmitter which can be used to monitor the state of the lock, to verify the authentication of a received transition signal or to signal a successful change in state. The apparatus can also include an external unit in electrical communication with the electronic control system and is adapted to allow a person to enter a code directing the locking system to transition between it locked state and its unlocked state or between its unlocked state and its locked state.

The present invention broadly relates to a method for locking a container, room, cavity, chamber, etc. having an openable opening including the step of installing within the container, etc., an internal locking apparatus of this invention. The method also includes the step of issuing a signal to the electronic control system to transition the locking system from its unlocked to its locked position when the opening is in its closed state. The method also includes the step of issuing a second signal to the electronic control system to transition the locking system from its locked position to its unlocked position. The method can also include the steps of loading and unloading contents out of or into the container's interior once the opening is opened. The method can also include the step of monitoring the state of the locking system remotely during transportation. The method can also include the step of transmitting the transition signals from a remote location via a transmitter such as a satellite, cell phone or any other wireless communication protocol. The method can also include the step of entering a code on an external unit. The external unit then issues an instruction to the electronic control system to transition the locking system form one state to another state.

The locking systems of this invention can be a worm screw drive, a linear actuator drive, a cam drive or any other electro-mechanical locking device. If the apparatus includes a plurality of locking assemblies, then each of the locking system can be independently selected from a list of acceptable electro-mechanical locking devices or they can all be controlled collectively so that a single command will simultaneously, near simultaneously or sequentially unlock all of the independent locking devices.

In one embodiment, the internal locking apparatus of this invention includes a locking system adapted to be mounted in an interior adjacent an openable member of a container and to transition between a first state and a second state, a locked state and an unlocked state. The apparatus also includes an electronic control system includes a command generator component adapted generate commands to the locking system causing the locking system to transition between its two states, and a power supply adapted to provide electric power to the locking system and the electronic control system. The locking system is an electro-mechanical device, which can be selected from the group consisting of a worm screw drive, a linear actuator drive, a cam drive, and mixtures or combinations thereof.

The apparatus can also include a plurality of locking systems adapted to be mounted in the interior of the container in a spaced apart manner adjacent the openable member, where each locking system is capable of independently transitioning between a first state and a second state, a locked state and an unlocked state. The electronic control system can be adapted to issue commands to the plurality of locking systems to cause the locking systems to simultaneously or near simultaneously transition between their two states. The electronic control system can be adapted to issue commands to the plurality of locking systems to cause the locking systems to sequentially transition between their two states.

The container is selected from the group consisting of a truck trailer, a cargo container, a building, a room, and storage area and the openable member is a door.

The electronic control system can further include a receiver component capable of receiving an activation signal, where the activation signal causes the electronic control system to issue a state transition command to the locking system. The electronic control system can further include a transmitter component capable of transmitting a completion signal and optionally capable of transmitting on request, intermittently, periodically or continuously a status signal.

The electronic control system can further include a receiver component capable of receiving an activation signal and a verification signal, where the activation signal causes the command generator component to either issue a state transition command to the locking system or an authentication command and the verification signal causes the command generator component to issue a state transition command to the locking system, and a transmitter component capable of transmitting an authentication signal upon receiving an authentication command from the command generation component, where authentication signal is adapted to authenticate the activation signal.

The electronic control can further includes an external entry component where the external entry component is in communication with the other components of the electronic control system and is capable of generating a state transition signal to command generator component, causing the locking system to transition between its two states. The external entry component includes an authentication component for authenticating use of the external entry component. The authentication component comprises a key or touch pad having a unique authentication code, a finger print pad, a palm print pad, or a retinal scanner.

In another embodiment, the internal locking apparatus of this invention includes a plurality of locking systems, where each locking system includes a locking assembly and an electronic control system adapted to provide power to its locking assembly and to issue commands to its locking assembly causing its locking assembly to transition between its two states, and where the locking assemblies are adapted to be mounted in the interior of the container in a spaced apart manner adjacent the openable member and to transition between their locked states and their unlocked states.

In these embodiments, each electronic control system is controlled via telemetry. In certain embodiments, each electronic control system has a separate telemetry frequency, code or a combination thereof to further increase security, where the telemetry is selected from the group consisting of Rf telemetry, IR telemetry, nearIR telemetry, sonic telemetry, microwave telemetry, and radar telemetry. In these embodiments, the electronic control system transitions the plurality of locking systems between their first states and their second states simultaneously or near simultaneously, where near simultaneous means that the transition codes are generated over a short period of time generally less than 10 second. Alternatively, the electronic control system transitions the plurality of locking systems between their first states and their second states sequentially. Again, the container is selected from the group consisting of a truck trailer, a cargo container, room, and storage area and the openable member is a door.

The present invention also relates to a method for controlling assess to a container comprising the step of providing a locking apparatus. The locking apparatus includes a locking system mounted on an inner surface of the container adjacent an openable member and capable of transitioning between a locked state and an unlocked state. The locking apparatus also includes an electronic control system mounted on the same or different inner surface of the container and in electrical communication with the locking system. The electronic control system includes a command generation component adapted generate and send commands to the locking system causing the locking system to transition between its two states and a receiver component capable of receiving an activation signal adapted to cause the electronic system to issue a command to the locking system causing the locking system to transition between its two states. The locking apparatus also includes a power supply mounted on the same or different inner surface of the container in electrical communication with the locking system and the electrical control system and adapted to supply electric power to the two systems.

The method also includes the steps of sending an unlock signal to the electronic control system, issuing an unlock command to the locking system causing it to transition between its locked state and its unlocked state, loading the container, sending a lock signal to the electronic control system, and issuing a lock command to the locking system causing it to transition between its unlocked state and its locked statee to communication with the locking system.

In certain embodiments, the method also includes the steps of transporting the container from a first location to a second location, issuing an unlock command to the locking system causing it to transition between its locked state and its unlocked state, and unloading the container.

In certain embodiments, the method also includes the steps of issuing an unlock command to the locking system causing it to transition between its locked state and its unlocked state, and unloading the container.

In certain embodiments, the electronic control system can further include a transmitting unit and the method further includes the steps of sending intermittent, periodic or continuous container status reports.

In certain embodiments, the method also includes the steps of sending an authentication signal after receiving a lock or unlock signal and receiving a verification signal.

In certain embodiments, the locking apparatus includes a plurality locking systems and a single electronic control system, where the locking systems are mounted adjacent th openable member in a spaced apart configuration.

In certain embodiments, the method includes a plurality of locking apparatuses, wherein the locking apparatuses are mounted adjacent th openable member in a spaced apart configuration and a controlled separately or collectively.

Suitable Materials

Suitable electro-mechanical drives for use in this invention include, without limitation, worm screw drives, linear actuator drives, cam type drives, rack and pinion drives or similar electro-mechanical drives manufactured by the following non-exclusive list of manufacturers: Motion Systems Corporation of Eatontown, N.J., Exlar Corporation of Chanhassen, Minn., Nook Industries, Inc. Of Cleveland, Ohio, Hoerbiger-Origa Corporation, North American corporate office, 100 West Lake Drive, Glendale Heights, Ill., California Linear Devices, Inc., 2236 Rutherford Road, Ste. 119, Carlsbad, Calif. 92008 USA, MACRON DYNAMICS, INC. of Horsham, Pa., Ultra Motion, 225 East Side Avenue, Mattituck, N.Y. 11952, Mechanical Components Pty Ltd, Aerotech, Inc., 101 Zeta Drive, Pittsburgh, Pa., Zero-Max, Inc. of Plymouth, Minn., Moog Components Group 1213 North Main Street, Blacksburg Va., Atlanta Drive Systems Inc., Wall, N.J., Bison Gear and Engineering Corp., St. Charles, Ill., Browning/Emerson Power Transmission, Ithaca, N.Y., Certified Reducer Rebuilders Inc., Madison Heights, Mich., DieQua Corp., Bloomingdale, Ill., Grupo M eusnier, S.A. de C.V. Naucalpan, Mexico, Milwaukee Gear Co., Milwaukee, Wis., Morse/Emerson Power Transmission, Ithaca, N.Y., Nissei Corporation Of America, Charlotte, N.C., Pamco Machine Works Inc., Monrovia, Calif., Philadelphia Gear Corp., Norristown, Pa., Premium Energy Transmission Limited, Pune, India, Quality Transmission Components, Garden City Park, N.Y., SEW-Eurodrive Inc., Lyman, S.C., Stock Drive Products, New Hyde Park, N.Y., Supreme Gear, Fraser, Mich., Torque Transmission, Fairport Harbor, Ohio, Tsubakimoto Chain Co., ASI Technologies Inc., Akron Gear and Engineering, American Gear & Engineering, Amko Gears (India), Atelier Vanhoute, Atlanta Drive Systems Inc., Bison Gear and Engineering Corp., Bodine Gear Manufacturing, Browning/Emerson Power Transmission, Certified Reducer Rebuilders Inc, Chenta Gear—USA, Cleveland Gear Co., Davall Gears, Delroyd Worm Gear, DieQua Corp., Electra-Gear, Elmrad Engineering Co. Pvt. Ltd., Engineered Technical Systems, FRAN SA de CV, Flender Corp., Foote-Jones, A Regal-Beloit Company, Forest City Gear Co., Gear Products Inc., Gibbs Gears Precision Engineers Ltd., Great Taiwan Gear, Grupo Meusnier, S.A. de C.V., High Power Gear Co., Hub City Inc., Jankat Gear and Machine, Milwaukee Gear Co., Morse/Emerson Power Transmission, NAMCO, Nissei Corporation Of America, Ontario Drive & Gear Ltd., Pamco Machine Works Inc., Peerless-Winsmith Inc, Penn Machine Co., Philadelphia Gear Corp., Premier Machine & Gear Ltd., Premium Energy Transmission Limited, Quality Gears, Quality Transmission Components, Rino Industries Ltd., S.P. Enterprise, SEW-Eurodrive Inc., SSJ Italy, Shanthi Gears, Stock Drive Products, Supreme Gear, Textron Power Transmission, Torque Transmission, Tsubakimoto Chain Co., or the like or mixtures or combinations thereof.

Suitable power supplies for use with the present invention include, without limitation, an DC battery, solar panels, AC power sources with DC converters, generators, alternators or other electrical systems that generate sufficient DC power to operate the drives and other electronic components of the locking apparatuses of this invention.

Suitable electronic control systems for use in this invention include, without limitation, electronic control systems from HYVAIR, Inc. which are keyless activated with remote units and operate at 300 MHz and have secure activation codes. The electronic control systems include a digital processing unit, a memory, an optional mass storage device, an operating system installed in the memory, communication hardware and software, and analog to digital conversion components if needed. The digital processing unit can be any digital processing unit sufficient to receive control signals and generate commands that cause the locking systems to transition between their two states.

Suitable external control units for use in this invention include, without limitation, keypads, touch pads, voice-activated device or any other electronic device that can receive a code, verify the code, generate an action signal and transmit the action signal. The electronic devices can also include a retinal scanner, a finger print scanner, a palm print scanner or other identification device.

Suitable receivers for use in this invention include, without limitation, Rf receivers, ultrasound receivers, microwave receivers, IR receivers, near IR receivers, radar receivers, laser receivers, or the like or mixtures or combinations thereof

Suitable transmitters for use in this invention include, without limitation, Rf transmitters, ultrasound transmitters, microwave transmitters, IR transmitters, near IR transmitters, radar transmitters, lasers or the like or mixtures or combinations thereof.

### DETAILED DESCRIPTION OF DRAWINGS

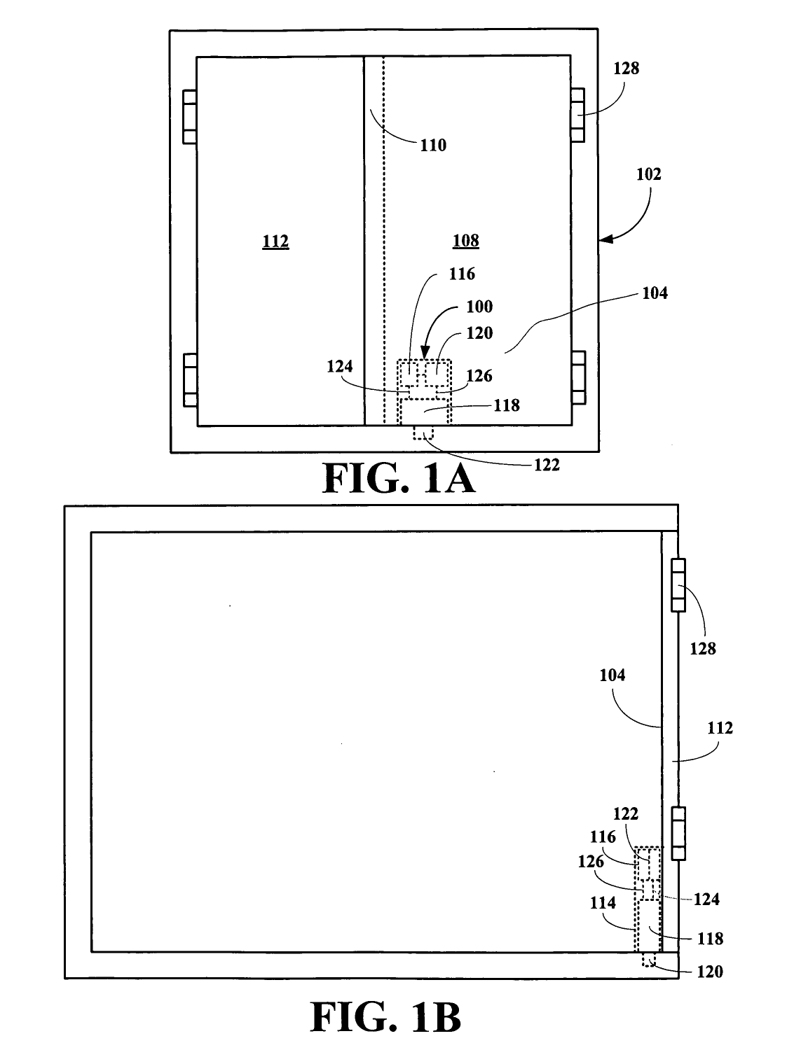

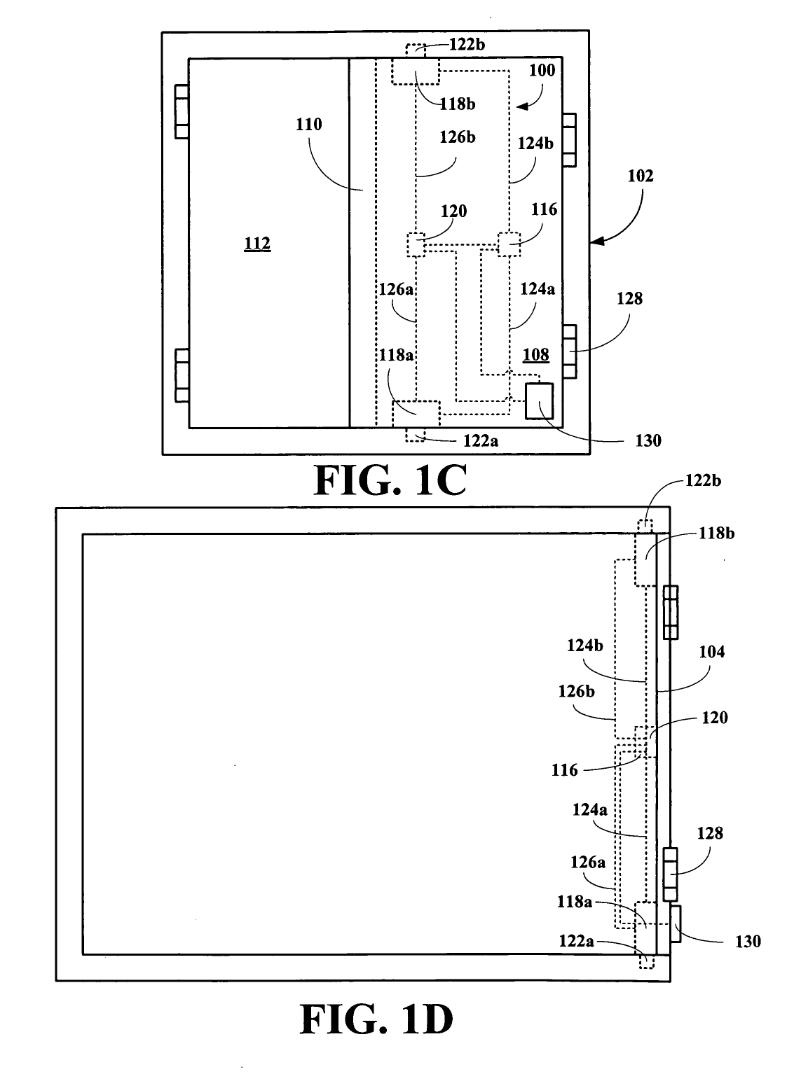

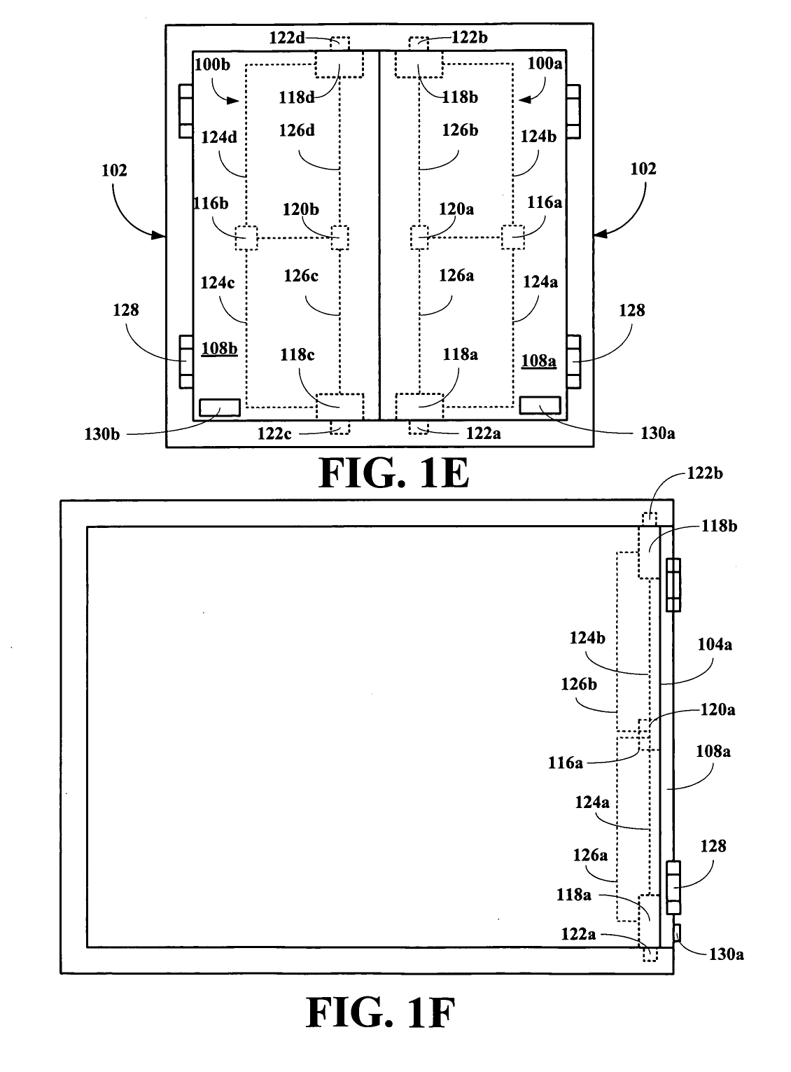

Referring now to FIGS. 1A&B, a preferred embodiment of an internal locking apparatus, generally 100, is shown. The apparatus 100 is mounted within a container 102 on an inner surface 104 of a double door 106, where one door 108 has a lip 110 that does not allow the other door 112 to be opened until and unless the first door 108 is opened first. The apparatus 100 includes a housing 114. Within the housing 114, the apparatus 100 includes a power supply 116, an electro-mechanical system 118 and an electronic control system 120. The electro-mechanical system 118 includes a retractable locking member 122. The power supply 116 is connected to the electro-mechanical system 118 via a first electrical conduit 124. The electro-mechanical system 118 is connected to the electronic system 120 via a second electrical conduit 126. The doors 108 and 112 are mounted on the container 102 via hinges 128. The container 102 can be a truck trailer, a cargo container (ship, rail or storage container), a building, a room, storage area, or the like.

Referring now to FIGS. 1C&D, another preferred embodiment of an internal locking apparatus, generally 100, is shown. The apparatus 100 is mounted within a container or room or the like 102 on an inner surface 104 of a double door 106, where one door 108 has a lip 110 that does not allow the other door 112 to be opened until and unless the first door 108 is opened first. The apparatus 100 includes a power supply 116, two electro-mechanical systems 118a&b, and an electronic control system 120. Each electro-mechanical system 118a or b includes a retractable locking member 122a&b. The power supply 116 is connected to the electro-mechanical systems 118a&b via first electrical conduits 124a&b. The electro-mechanical systems 118a&b is connected to the electronic system 120 via second electrical conduits 126a&b. The doors 108 and 112 are pivotally mounted on the container 102 via hinges 128. The apparatus 100 can also include an external electronic unit 130 in electrical communication with the electronic control system 120 and where the external electronic unit 130 is adapted to allow a person to enter a code to direct the electronic control system 120 to cause the electro-mechanical systems 118a&b to transition between their two states. The container 102 can be a truck trailer, a ship cargo container, a storage room, or the like.

In this embodiment, the two electro-mechanical systems 118a&b can be controlled independently or collectively depending on the degrees of security desired. If independently controlled, then a telemetry signal must be sent to the electronic system 112 which then activates each electro-mechanical system 118a&b when its authorization code is sent to cause a transition in the electro-mechanical system's state. The two electro-mechanical system 118a&b are shown disposed on the top and bottom of the container 102.

Referring now to FIGS. 1E&F, another preferred embodiment of an internal locking apparatus, generally 100, is shown. Two apparatuses 100a&b are mounted within a container 102 on inner surfaces 104a&b of a double door 106 having doors 108a&b. The apparatus 100a includes a power supply 116a, two electro-mechanical systems 118a&b, and an electronic control system 120a. The electro-mechanical system 118a&b include a retractable locking member 122a&b. The power supply 116a is connected to the electro-mechanical systems 118a&b via hydraulic conduits 124a&b. The electro-mechanical systems 118a&b are connected to the electronic system 120a via electrical conduits 126a&b. The apparatus 100b includes a power supply 116b, two electro-mechanical systems 118c&d, and an electronic control system 120b. Each of the electro-mechanical systems 118c&d include a retractable locking member 122c&d. The power supply 116b is connected to the electro-mechanical systems 118c&d via hydraulic conduits 124c&d. The electro-mechanical systems 118d&d are connected to the electronic system 120b via electrical conduits 126c&d. The doors 108a&b are pivotally mounted on the container 102 via hinges 128. The apparatuses 100a&b each can also include an external electronic unit 130a&b in electrical communication with its respective electronic control system 120a&b and where the external electronic units 130a&b are adapted to allow a person to enter a code to direct the electronic control systems 120a&b, collectively or individually, to cause the electro-mechanical systems 118a-d to transition between their two states. The container 102 can be a truck trailer, a ship cargo container, or the like. The container 102 can be a truck trailer, a ship cargo container, or the like.

In this embodiment, each of the electro-mechanical systems 118c-d can be controlled independently or collectively depending on the degree of security desired. If independently controlled, then a telemetry signal must be sent to the electronic systems 120a&b which then activates each of electro-mechanical system 118a-d when its authorization code is sent to cause a transition in the electro-mechanical system's state. The two electro-mechanical systems 118a&c are shown disposed on bottoms 132a&b of the doors 108a&b; while the other two electro-mechanical systems 118b&d are shown disposed on tops 134a&b of the doors 108a&b.

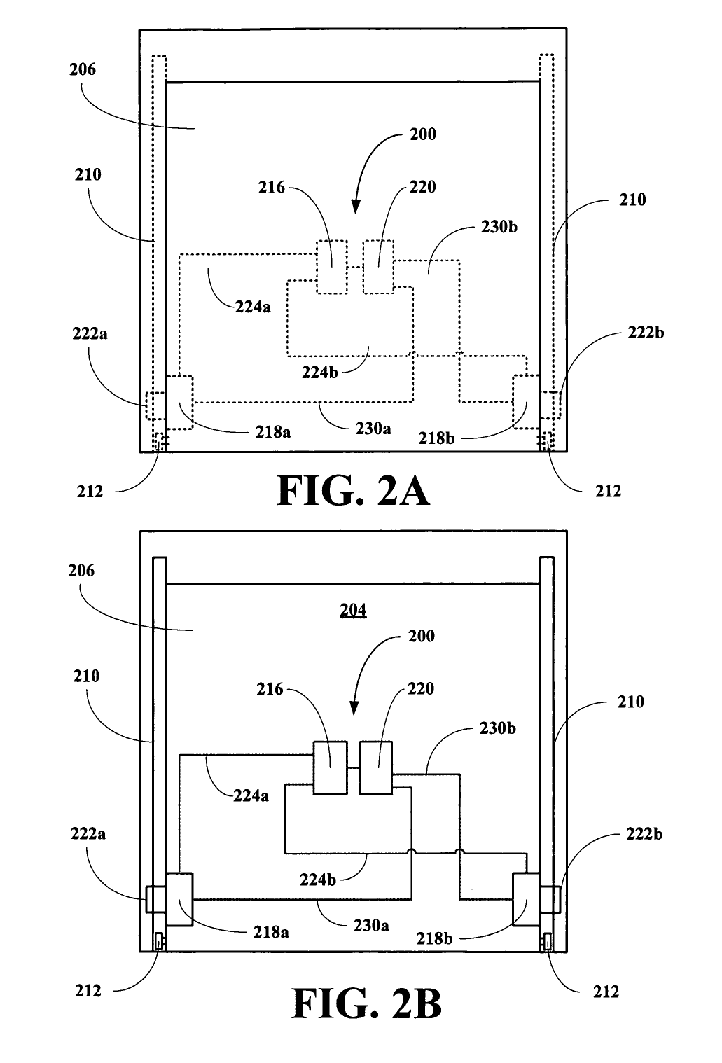

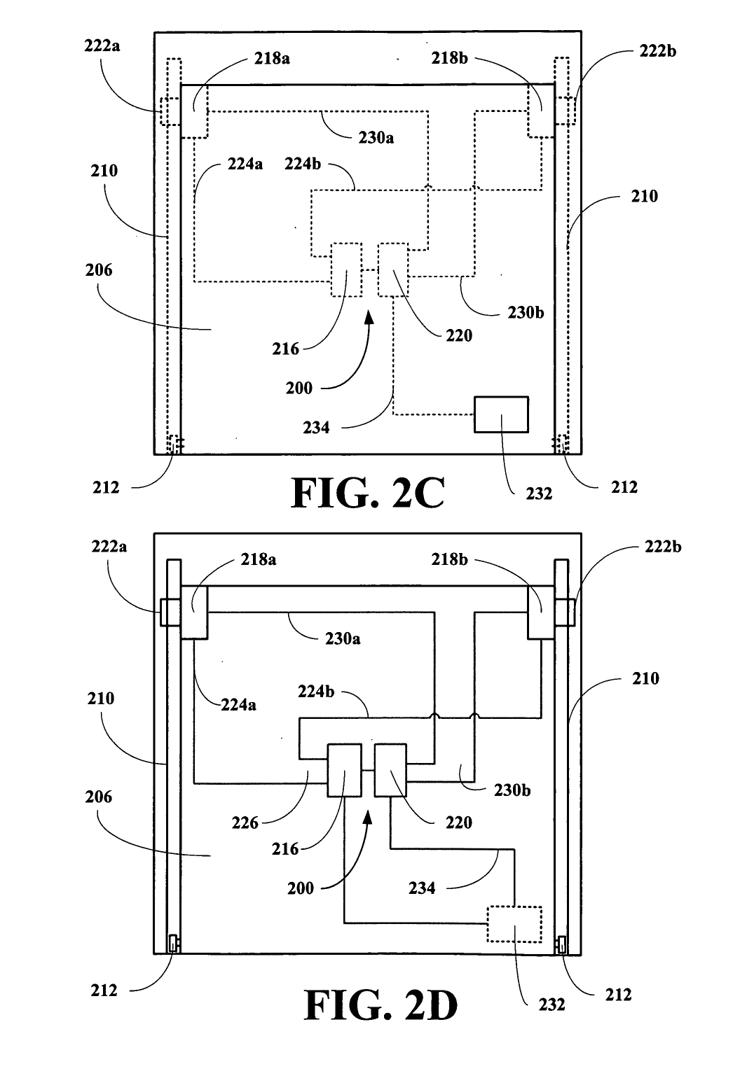

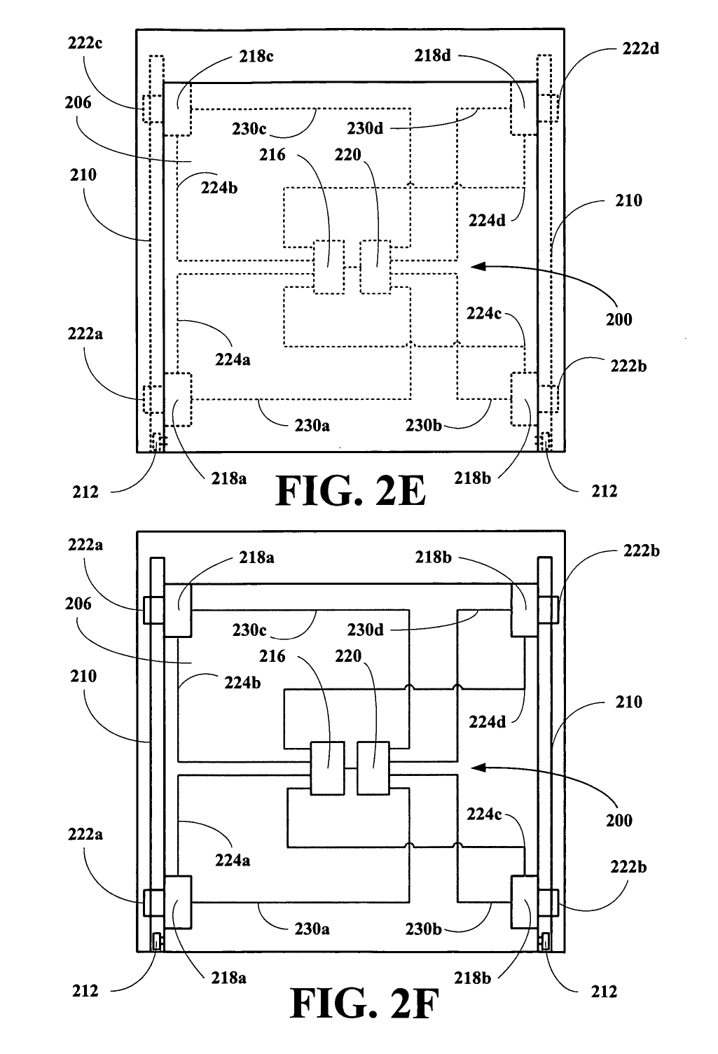

Referring now to FIGS. 2A&B, another preferred embodiment of an internal locking apparatus, generally 200, is shown. The apparatus 200 is mounted within a container 202 on an inner surface 204 of a sliding door 206, where the door 208 runs in a track 210 via wheels 212. The apparatus 200 includes a power supply 216, a left electro-mechanical system 218a, a right electro-mechanical system 218b, and an electronic control system 220. The electro-mechanical systems 218a&b include retractable locking members 222a&b. The power supply 216 is connected to the electro-mechanical systems 218a&b via electrical lines 224a&b. The electro-mechanical systems 218a&b are connected to the electronic system 220 via electrical wires 230a&b. The container 202 can be a truck trailer, a ship cargo container, or the like.

Referring now to FIGS. 2C&D, a preferred embodiment of an internal locking apparatus, generally 200, is shown. The apparatus 200 is mounted within a container 202 on an inner surface 204 of a double door 206, where the door 208 runs in a track 210 via wheels 212. The apparatus 200 includes a power supply 216, two electro-mechanical systems 218a&b, and an electronic control system 220. The power supply 216 is connected to the electro-mechanical systems 218a&b via hydraulic lines 222a&b originating at a T-junction 224 connected to the power supply 216 via a hydraulic feed line 226. The electro-mechanical systems 218a&b are connected to the electronic system 220 via electrical wires 228a&b. The electro-mechanical systems 218a&b are connected to the electronic system 220 via electrical wire 230a&b. The apparatus 200 can also include an external electronic unit 232 in electrical communication with the electronic control system 220 via a electric wire 234 and where the external electronic unit 230 is adapted to allow a person to enter a code to direct the electronic control system 220 to cause the electro-mechanical systems 218a&b to transition between their two states. The container 202 can be a truck trailer, a ship cargo container, or the like.

In this embodiment, the two electro-mechanical systems 218a&b can be controlled independently or collectively depending on the degrees of security desired. If independently controlled, then a telemetry signal must be sent to the electronic system 212 which then activates each electro-mechanical system 218a&b when its authorization code is sent to cause a transition in the electro-mechanical system's state. The two electro-mechanical system 218a&b are shown disposed

Referring now to FIGS. 2E&F, a preferred embodiment of an internal locking apparatus, generally 200, is shown. Two apparatuses 200a&b are mounted within a container 202 on inner surfaces 204a&b of a double door 206 having doors 208a&b. The apparatus 200a includes a power supply 216a, two electro-mechanical systems 218a&b, and an electronic control system 220a. The electro-mechanical system 218a&b include a retractable locking member 222a&b. The power supply 216a is connected to the electro-mechanical systems 218a&b via hydraulic conduits 224a&b. The electro-mechanical systems 218a&b are connected to the electronic system 220a via electrical conduits 226a&b. The apparatus 200b includes a power supply 216b, two systems 218c&d, and an electronic control system 220b. Each of the electro-mechanical systems 218c&d include a retractable locking member 222c&d. The power supply 216b is connected to the electro-mechanical systems 218c&d via hydraulic conduits 224c&d. The electro-mechanical systems 218d&d are connected to the electronic system 220b via electrical conduits 226c&d. The doors 208a&b are pivotally mounted on the container 202 via hinges 228. The apparatuses 200a&b each can also include an external electronic unit 230a&b in electrical communication with its respective electronic control system 220a&b and where the external electronic units 230a&b are adapted to allow a person to enter a code to direct the electronic control systems 220a&b, collectively or individually, to cause the electro-mechanical systems 218a-d to transition between their two states. The container 202 can be a truck trailer, a ship cargo container, or the like. The container 202 can be a truck trailer, a ship cargo container, or the like.

In this embodiment, each of the electro-mechanical systems 218c-d can be controlled independently or collectively depending on the degree of security desired. If independently controlled, then a telemetry signal must be sent to the electronic systems 220a&b which then activates each of electro-mechanical system 218a-d when its authorization code is sent to cause a transition in the electro-mechanical system's state. The two electro-mechanical systems 218a&c are shown disposed on bottoms 232a&b of the doors 208a&b; while the other two electro-mechanical systems 218b&d are shown disposed on tops 234a&b of the doors 208a&b.

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

We claim:

1. An internal locking apparatus comprising:
a locking system adapted to be mounted in an interior adjacent an openable member of a container and to transition between a first state and a second state, a locked state and an unlocked state,
an electronic control system includes a command generator component adapted generate commands to the locking system causing the locking system to transition between its two states, and
a power supply adapted to provide electric power to the locking system and the electronic control system.

2. The apparatus of claim 1, wherein the locking system is an electro-mechanical device.

3. The apparatus of claim 1, wherein the electro-mechanical device is selected from the group consisting of a worm screw drive, a linear actuator drive, a cam drive, and mixtures or combinations thereof.

4. The apparatus of claim 1, further comprising a plurality of locking systems adapted to be mounted in the interior of the container in a spaced apart manner adjacent the openable member, where each locking system is capable of independently transitioning between a first state and a second state, a locked state and an unlocked state.

5. The apparatus of claim 4, wherein the electronic control system is adapted to issue commands to the plurality of locking systems to cause the locking systems to simultaneously or near simultaneously transition between their two states.

6. The apparatus of claim 4, wherein the electronic control system is adapted to issue commands to the plurality of locking systems to cause the locking systems to sequentially transition between their two states.

7. The apparatus of claim 1, wherein the container is selected from the group consisting of a truck trailer, a cargo container, a building, a room, and storage area.

8. The apparatus of claim 1, wherein the openable member is a door.

9. The apparatus of claim 1, wherein the electronic control system further includes a receiver component capable of receiving an activation signal, where the activation signal causes the electronic control system to issue a state transition command to the locking system.

10. The apparatus of claim 1, wherein the electronic control system further includes a transmitter component capable of transmitting a completion signal and optionally capable of transmitting on request, intermittently, periodically or continuously a status signal.

11. The apparatus of claim 1, wherein the electronic control system further includes
a receiver component capable of receiving an activation signal and a verification signal, where the activation signal causes the command generator component to either issue a state transition command to the locking system or an authentication command and the verification signal causes the command generator component to issue a state transition command to the locking system, and
a transmitter component capable of transmitting an authentication signal upon receiving an authentication command from the command generation component, where authentication signal is adapted to authenticate the activation signal.

12. The apparatus of claim 1, wherein the electronic control further includes an external entry component where the external entry component is in communication with the other components of the electronic control system and is capable of generating a state transition signal to command generator component, causing the locking system to transition between its two states.

13. The apparatus of claim 1, wherein the external entry component includes an authentication component for authenticating use of the external entry component.

14. The apparatus of claim 1, wherein the authentication component comprises a key or touch pad having a unique authentication code, a finger print pad, a palm print pad, or a retinal scanner.

15. An internal locking apparatus comprising:
a plurality of locking systems, where each locking system includes a locking assembly and an electronic control system adapted to provide power to its locking assembly and to issue commands to its locking assembly causing its locking assembly to transition between its two states, and where the locking assemblies are adapted to be mounted in the interior of the container in a spaced apart manner adjacent the openable member and to transition between their locked states and their unlocked states.

16. The apparatus of claim 15, wherein each electronic control system is controlled via telemetry.

17. The apparatus of claim 15, wherein each electronic control system has a separate telemetry frequency, code or a combination thereof to further increase security.

18. The apparatus of claim 15, wherein the telemetry is selected from the group consisting of Rf telemetry, IR telemetry, nearIR telemetry, sonic telemetry, microwave telemetry, and radar telemetry.

19. The apparatus of claim 15, wherein the electronic control system transitions the plurality of locking systems between their first states and their second states simultaneously or near simultaneously.

20. The apparatus of claim 15, wherein the electronic control system transitions the plurality of locking systems between their first states and their second states sequentially.

21. The apparatus of claim 15, wherein the container is selected from the group consisting of a truck trailer, a cargo container, room, and storage area.

22. The apparatus of claim 15, wherein the openable member is a door.

23. A method for controlling assess to a container comprising the steps of:
providing a locking apparatus including:
a locking system mounted on an inner surface of the container adjacent an openable member and capable of transitioning between a locked state and an unlocked state;
an electronic control system mounted on the same or different inner surface of the container and in electrical communication with the locking system and including:
a command generation component adapted generate and send commands to the locking system causing the locking system to transition between its two states and
a receiver component capable of receiving an activation signal adapted to cause the electronic system to issue a command to the locking system causing the locking system to transition between its two states
a power supply mounted on the same or different inner surface of the container in electrical communication with the locking system and the electrical control system and adapted to supply electric power to the two systems;
sending an unlock signal to the electronic control system,
issuing an unlock command to the locking system causing it to transition between its locked state and its unlocked state,
loading the container;
sending a lock signal to the electronic control system,
issuing a lock command to the locking system causing it to transition between its unlocked state and its locked statee to communication with the locking system.

24. The method of claim 23, further comprising the steps of:
transporting the container from a first location to a second location,
issuing an unlock command to the locking system causing it to transition between its locked state and its unlocked state, and
unloading the container.

25. The method of claim 23, further comprising the steps of:
issuing an unlock command to the locking system causing it to transition between its locked state and its unlocked state, and
unloading the container.

26. The method of claim 23, wherein the electronic control system further includes:
a transmitting unit and
the method further comprising the steps of:
sending intermittent, periodic or continuous container status reports.

27. The method of claim 23, further comprising the steps of:
sending an authentication signal after receiving a lock or unlock signal; and
receiving a verification signal.

28. The method of claim 23, wherein the locking apparatus includes a plurality locking systems and a single electronic control system, where the locking systems are mounted adjacent th openable member in a spaced apart configuration.

29. The method of claim 23, further comprising a plurality of locking apparatuses, wherein the locking apparatuses are mounted adjacent th openable member in a spaced apart configuration.
